(19) United States
(12) Patent Application Publication
(10) Pub. No.: US 2025/0370942 A1
(43) Pub. Date: Dec. 4, 2025

(54) APPLICATION OFFLOAD ACCELERATOR DEVICE

(71) Applicant: Advanced Micro Devices, Inc., Santa Clara, CA (US)

(72) Inventor: Allen HUBBE, Durham, NC (US)

(21) Appl. No.: 18/680,928

(22) Filed: May 31, 2024

(51) Int. Cl. G06F 13/28

(52) U.S. Cl. CPC G06F 13/28; G06F 2213/28

(57) ABSTRACT

Embodiments herein describe an application offload accelerator device (i.e., an application accelerator). In an example, an application accelerator detects an IO transaction related to an application program executing on a processor and performs (i.e., offloads) a function of the application program based on the IO transaction. The application program may allocate a buffer in the memory, configure a direct memory access (DMA) engine of an IO device to write to the buffer, and configure the application accelerator to detect the IO transaction related to the application program based on a destination addresses of a write transaction of the DMA engine. The application accelerator include discrete-logic and programmable match-action tables.

### TECHNICAL FIELD

Examples of the present disclosure generally relate to an application offload accelerator device.

### BACKGROUND

A processor may offload a computationally-intensive data processing function of an application program to a hardware (i.e., discrete-logic) accelerator circuit that is designed to perform the particular function more efficiently (e.g., with lower latency and/or lower power consumption). Although there may be other functions of the application program, such as data management functions related to input/output transactions, it may not be economically feasible/practical to design hardware accelerators for such other tasks.

### SUMMARY

Techniques for application offload acceleration are described. One example is a system that includes a processor, memory encoded with an application program that comprises instructions that, when executed by the processor, cause the processor to perform a first function, and an application accelerator that detects an input/output (IO) transaction related to the application program and performs a second function based on the detected IO transaction.

Another example described herein is an integrated circuit (IC) device that includes an application accelerator circuit that detects an IO transaction related to an application program executing on a processor, and perform a function based on the IO transaction.

Another example described herein is method that includes monitoring a direct memory access (DMA) channel, by an application accelerator circuit, based on a match-action function that includes an input/output (IO) transaction pattern and a corresponding action, detecting an IO transaction of the DMA channel that matches the IO transaction pattern, by the application accelerator circuit, based on the monitoring, and performing the action, by the application accelerator circuit, based on the detecting.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a block diagram of a system that includes a processor system and a configurable application accelerator that performs or offloads functions of an application program based on transactions of input/output (IO) devices, according to an embodiment.

FIG. 2 is a block diagram of the system of FIG. 1, including examples buffer, according to an embodiment.

FIG. 3 is a block diagram of the system, including multiple IO devices, according to an embodiment.

FIG. 4 is a block diagram of a distributed services platform that includes an pipeline-based application accelerator, according to an embodiment.

FIG. 5 illustrates a method, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe an application offload accelerator device, which may also be referred to as an application accelerator.

As a processor executes an application program, the processor performs functions that involve internal busses of the processor, cache coherency protocols, scheduling, and more. Many of the processes are relatively simple and routine, yet contribute significant to latency of a critical path. As an example, the processor may exchange information with an input/output (IO) device via memory allocated to the application program. The allocated memory may include a submission queue, a receive queue, and a completion queue. The processor may populate the submission queue with outgoing messages to be sent by the IO device, and the IO device may populate the receive queue with incoming messages directed to the application program. After each IO transaction, the IO device may write a completion transaction to the completion queue, and may wait for a response from the processor before performing a subsequent IO transaction. The processor may periodically poll the completion queue to detect new completion transactions, or may read the completion queue based on an interrupt from the IO device. For each new completion transaction, the processor may perform one or more functions based on the corresponding IO transaction.

An application accelerator, as disclosed herein, performs (i.e., offloads) functions of an application program executing on a processor. In an example, the application accelerator performs functions based on IO transactions associated with the application program. The functions may include, without limitation, controlling an IO device to perform a subsequent IO transaction, posting work to a submission queue, extracting a payload of an IO transaction, decoding the payload as an application-specific completion descriptor, performing a branch operation based on the application-specific completion descriptor, attaching timestamps to the IO transactions, performing transaction-level analyses, and/or error detection. The application accelerator may be configurable to perform one or more of a variety of functions based on one or more of a variety of factors associated with IO transactions.

The application accelerator may employ match-action semantics to quickly determine an appropriate function/action based on features of the IO transactions, as opposed to an interrupt driven or polling model. Match-action semantics may permit the application accelerator to perform or initiate actions with extremely short reaction times relative to triggering events (e.g., IO transactions). The application accelerator may perform multiple match-action functions in a sequential or chained manner. The application accelerator may employ configurable match-action semantics, which may be useful to accommodate a variety of functions, situations, and/or application programs.

The application accelerator may be placed in a device tree between a host port and other devices, where it can quickly react to transactions on a bus, without having to wait for a processor to respond to the transactions. The application accelerator may act without interfering with existing traffic/transactions (i.e., may pass completion transactions and/or interrupts from IO devices to the processor). The application accelerator may inform/notify the processor of completion transactions related to the application program. The application accelerator may serve and/or appear as a switch. The application accelerator may mimic a PCIe device in a PCIe hierarchy, and may present itself as a PCIe switch that has additional functionality.

The application accelerator may be useful as a flexible, low-latency offload solution for application programs. The application accelerator may be useful for performing relatively simple and/or varied functions of an application program. The application accelerator is not, however, limited to relatively simple functions.

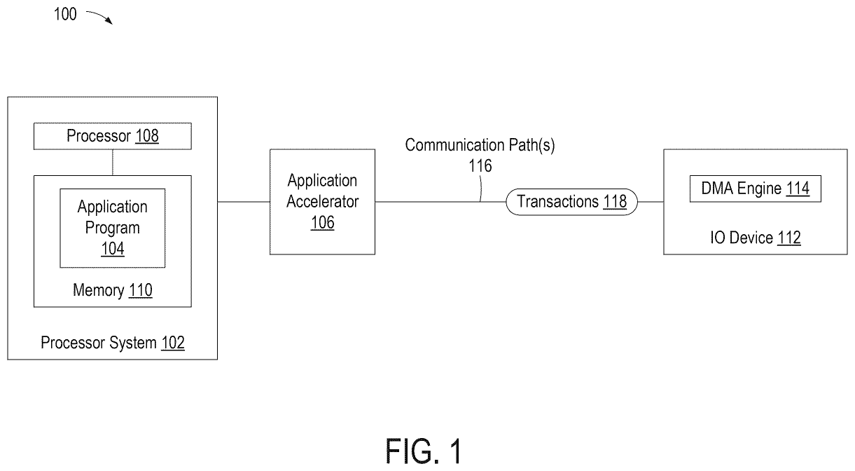

FIG. 1 is a block diagram of a system 100 that includes a processor system 102 and a configurable/programmable application accelerator 106 that performs (i.e., offloads) functions of an application program 104 based on transactions 118 of an input/output (IO) device 112, according to an embodiment. Processor system 102 includes a processor 108 and memory 110 encoded with application program 104. Application program 104 includes instructions that, when executed by processor 108, cause processor 108 to perform application functions (e.g., data processing functions).

System 100 may represent one or more integrated circuit devices. Application accelerator 106 may include a processor and memory encoded with application acceleration instructions. Alternatively, or additionally, application accelerator 106 may include hardware/circuitry (e.g., combinational and/or sequential logic, programmable circuitry/logic, look-up tables, and/or a state machine). In an example, application accelerator 106 includes programmable look-up tables and discrete-logic match-action circuitry that employs match-action semantics to quickly determine an appropriate function/action based on features of transactions 118. Application accelerator 106 may be provided on-chip (i.e., within the same IC package) with processor system 102. Alternatively, application accelerator 106 may be provided off-chip of processor system 102.

IO device 112 may represent, for example and without limitation, a network interface controller (NIC), a storage device, a graphics card, and/or other ID device(s). IO device 112 may, for example, represent a non-volatile memory express (NVMe) storage device. IO device 112 may include a local direct memory access (DMA) engine 114 that exchanges information with processor system 100 via buffers in memory 110. Alternatively, or additionally DMA engine 114 may include a remote DMA (RDMA) engine that interfaces with a RDMA IO device of a remote system. A RDMA engine may be useful to write directly to memory of the remote system without involving a processor of the remote system.

IO device 112 communicates with processor system 102 over a communication path(s) 116. IO device 112 may communicate with processor system 102 in accordance with a peripheral component interconnect express (PCIe) standard managed by the Peripheral Component Interconnect Special Interest Group (PCI-SIG) of Beaverton, OR. In the PCIe example, application accelerator 106 may present itself as a PCIe switch. In another example, IO device 112 may communicate with processor system 102 in accordance with a TCP/IP protocol, a 10 gigabit media-independent interface (XGMII) protocol defined in IEEE standard 803.2, and/or other protocol(s).

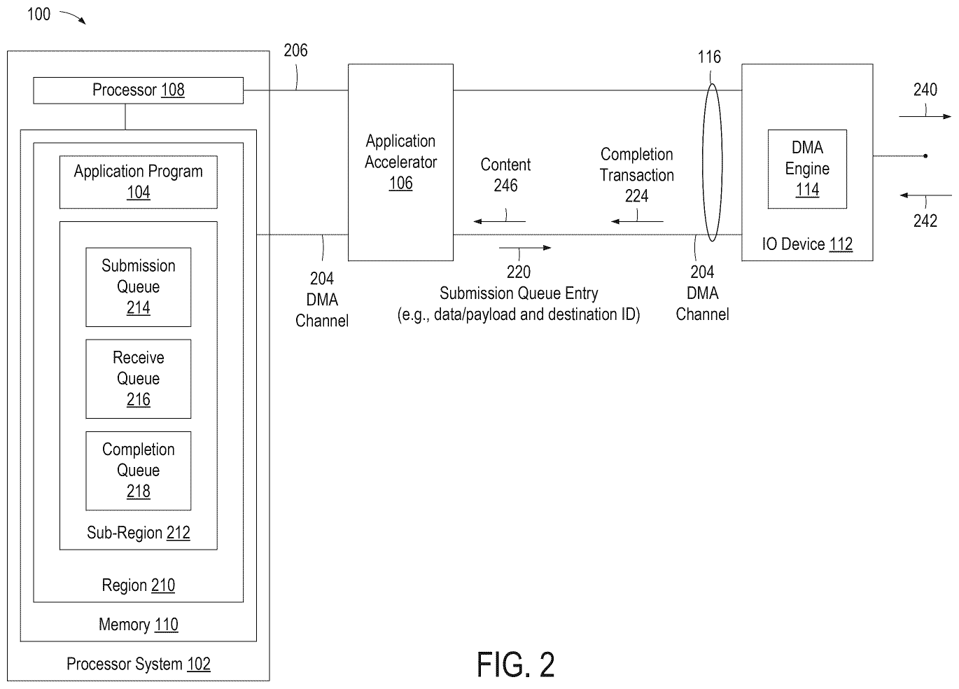

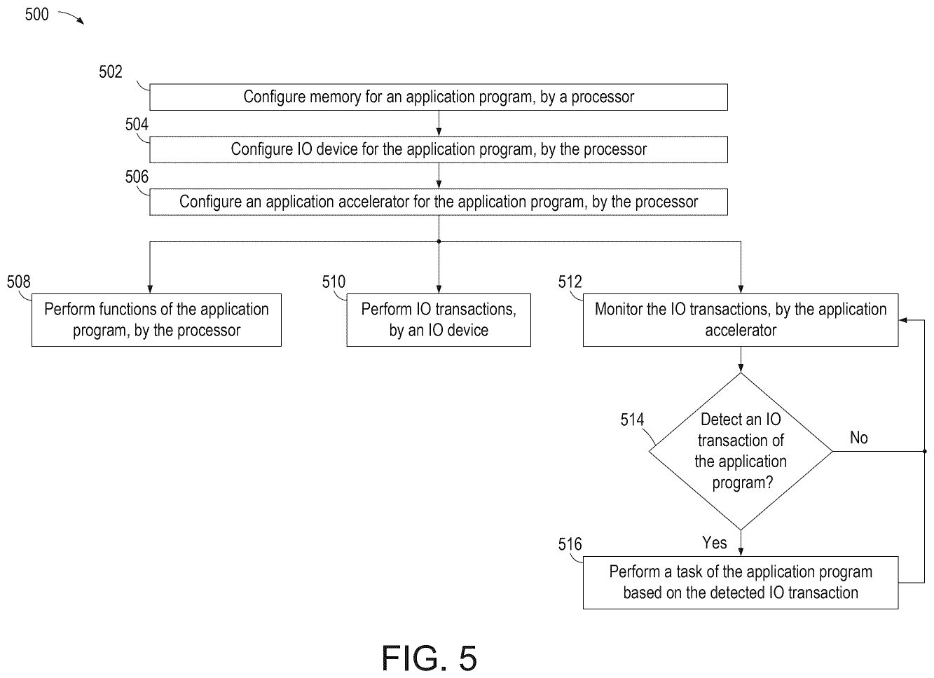

FIG. 2 is a block diagram of system 100, including example buffers, according to an embodiment. In the example of FIG. 2, DMA engine 114 accesses the buffers via a DMA channel 204. DMA engine 114 and application program 104 may exchange information with one another via the buffers, such as described further below with reference to FIG. 5.

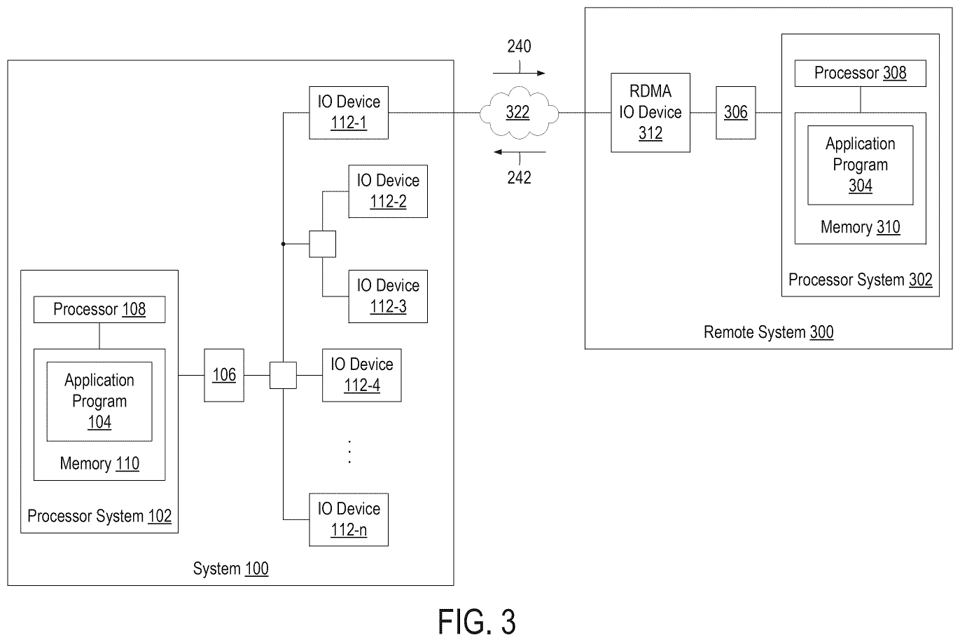

FIG. 3 is a block diagram of system 100, including multiple IO devices 112-1 through 112-n, according to an embodiment. In the example of FIG. 3, IO device 112-1 interfaces with a RDMA IO device 312 of a remote system 300 to send messages 240 and to receive messages 242 over a network 322. Remote system 300 may include a remote processor 308 that executes an application program 304 encoded within memory 3010. Remote system 300 may further include an application accelerator 306. FIG. 3 is described further below with reference to FIG. 5.

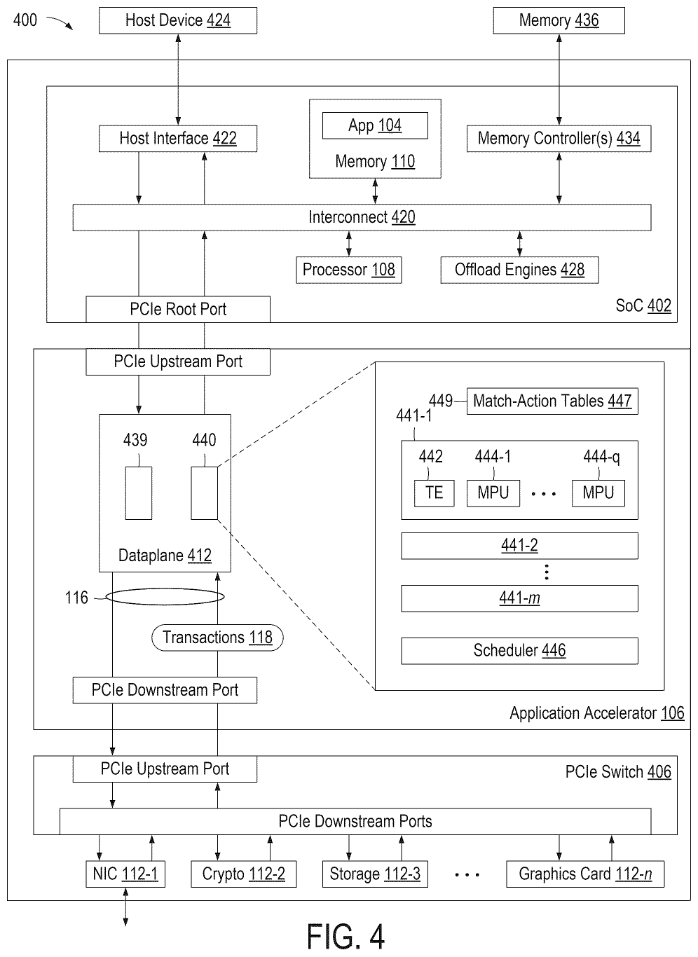

Application accelerator 106 may be implemented as a data processing pipeline of a distributed services platform, such as described below with reference to FIG. 4. FIG. 4 is a block diagram of a distributed services platform (platform) 400 that includes an pipeline-based application accelerator, according to an embodiment. Platform 400 may represent an integrated circuit (IC) device, which may include one or more IC dies and/or one or more circuit cards. In the example of FIG. 4, platform 400 includes a system-on-chip (SoC) 402, a pipeline-based application accelerator 106, a PCIe switch 406, and IO devices 112. In the example of FIG. 4, IO devices 112 include a network interface controller (NIC) 112-1, a cryptographic device 112-2, a storage device 112-3, and a graphics card 112-n. Platform 400 is not, however, limited to the foregoing examples.

SoC 402 includes processor 108 and memory 110 encoded with application program 104. Processor 108 may include, without limitation, one or more reduced-instruction set computer (RISC) processors, such as ARM processors marketed by Arm Holdings plc, of Cambridge, England.

SoC 402 may further include a host interface 422 (e.g., a PCIe host interface) that interfaces with a host device 424 and/or an external IO device(s). Host interface 422 may present itself to host device 424 as a PCIe device on a PCIe bus. Host interface 422 may include multiple PCIe lanes that may connect to other devices. As an example, host interface 422 may be configured as a PCIe root complex, and the PCIe lanes may connect to multiple host devices and/or multiple NVMe drives.

SoC 402 may further include one or more offload engines 428. Offload engine(s) 428 may perform one or more of a variety of functions of application program 104 and/or function of host device 424. As examples, and without limitation, offload engine(s) 428 may include a cryptographic engine, an error detection engine, and/or an error detection and correction engine. SoC 402 may further include a memory controller 434 (e.g., a DMA controller) that accesses external memory 436. SoC 402 may further include an interconnect 420 that interfaces with processor 108, memory 110, host interface 422, memory controller(s) 434, offload engines 428, IO devices 408, and application accelerator 106. Interconnect 420 may include a packet-based network-on-chip (NoC).

In FIG. 4, application accelerator 106 includes a dataplane 412 that includes a data processing pipeline 440 that performs functions of application program 104 based on transactions 118 related to application program 104. Dataplane 412 may further include a data processing pipeline 439 that performs functions of application program 104 based on transactions sent to IO devices 408 that are related to application program 104.

In the example of FIG. 4, pipeline 440 includes processing stages 441-1 through 441-m (collectively, processing stages 441), and programmable match-action tables 447 stored in memory 449. Processing stages 441 perform functions of application program 104 based transactions 118. Processing stage 441-1 is described below. Processing stages 441-2 through 441-m may be similar or identical to processing stage 441-1.

Processing stage 441-1 includes one or more instruction processors, illustrated here as match-processing units (MPUs) 444-1 through 444-q (collectively, MPUs 444) that perform functions of application program 104. Processing stage 441-1 further includes a discrete-logic match-action circuit, illustrated here as a table engine (TE) 442, that identifies one more match-action tables 447 based a transaction 118. Match-action tables 447 may include instructions for execution by MPUs 444, to cause MPUs 444 to perform functions of application program 104. TE 442 may provide the instructions of matching match-action tables 447 to MPUs 444. Pipeline 440 may be programmed based on the P4 programming language described in a P4Runtime Specification managed by the Open Networking Foundation (ONF) of Palo Alto, CA.

Pipeline 440 further includes a scheduler 646 that schedule processing activities of MPUs of processing stages 441. Application accelerator 106 is not limited to the example of FIG. 4.

FIGS. 1 through 4 are described below with reference to FIG. 5. FIG. 5 illustrates a method 500, according to an embodiment. Method 500 is described below with reference to FIGS. 1 through 3. Method 500 is not, however, limited to the examples of FIGS. 1 through 3.

At 502, application program 104 (i.e., via processor 108) configures one or more buffers within memory 110 for use by application program 104. In FIG. 2, application program 104 allocates a region 210 of memory 110 for use by application program 104, allocates a sub-region 212 for IO device 112, and allocates one or more buffers within sub-region 212 for exchanging information between processor 108 and IO device 112 (e.g., DMA engine 114). In the example of FIG. 2, application program 104 establishes or allocates a submission queue 214 for outgoing information, a receive queue 216 for incoming information, and a completion queue 218 for recording completed IO transactions that relate to application program 104. Buffer types, structure, and content are application-specific and are not limited to the examples of FIG. 2. Additional examples are provided below.

Application program 104 may allocate one or more of a variety of types of queues. As an example, where DMA engine 114 includes a RDMA engine, completion queue 218 may include an RDMA completion queue. As another example, in FIG. 3, processor 108 may include a local graphics processing unit (GPU), processor 308 of remote system 300 may include a remote GPU, and application program 104 may allocate completion queue 218 and/or other application specific queue(s) with corresponding semantics. Examples are provided below.

An application specific queue may include, without limitation, a low latency queue type, such as an NVIDIA Collective Communications Library (NCCL) that provides inter-GPU communication between software components of an application program that execute on the GPUs. The software components may be referred to as “shaders.” Absent application accelerator 106, when a NCCL low latency (LL) ring is produced into by the software on a local GPU, to be consumed by software on a remote GPU, the NCCL LL ring is proxied by software running on the local CPU. The application software on the local CPU observes when software on the local GPU produces data into the NCCL LL proxy ring by constantly reading the contents of the NCCL LL proxy ring and observing when the contents changes. The application software on the CPU then submits RDMA work requests to a local RDMA IO device to copy the contents of the NCCL LL proxy ring to the remote GPU using a remote RDMA IO device. The involvement of software on the CPU to proxy the NCCL LL ring contributes substantially to the overall latency, from when the software on the local GPU produces the data into the NCCL LL proxy ring, to when the data is available to software on the remote GPU. With application accelerator 106, the NCCL LL proxy ring buffer and associated application behavior can be registered with accelerator application accelerator 106. Unlike the software that would otherwise run on the CPU to react after observing a change in the contents of the NCCL LL ring, the application accelerator may instead be programmed to directly match and react to the PCIe memory write transactions passing through it, coming from the GPU that cause the contents of the NCCL LL proxy ring to change. In this example, application program 104 may program the action to immediately submit RDMA IO requests to copy the updated part of the NCCL LL proxy ring to the remote GPU. Using the application accelerator in this way can substantially reduce the overall latency of proxying the NCCL LL ring to a remote GPU. The local GPU (i.e., processor 108) may register a portion of sub-region 212 as an NCCL queue such that, when application program 104 writes to the NCCL, application accelerator 106 automatically posts RDMA work requests to IO device 112-1, and controls RDMA IO device 312 to mirror the NCCL queue contents into the remote GPU.

To reiterate, buffer types, structure, and content are application-specific and are not limited to the foregoing examples.

At 504, application program 104 configures IO device(s) 112, via processor 108. In FIG. 2, application program 104 registers sub-region 212 with DMA engine 114. Registration essentially informs DMA engine 114 to use submission queue 214, receive queue 216, and completion queue 218 for IO transactions related to application program 104. Processor 108 may further configure IO device 112 to identify incoming messages 242 that relate to application program 104 (e.g., based on destination addresses, header information, and/or other features of incoming messages 242). Processor 108 may further configure IO device 112 to format entries of submission queue 214 as outgoing messages 240.

At 506, application program 104 (i.e., via processor 108), configures application accelerator 106 to perform functions of application program 104. Application program 104 may program application accelerator 106 with application-specific logic appropriate for the structure and content of the buffers established at 502. For example, if the buffers include an RDMA completion queue, application program 104 may program application accelerator 106 to match DMA writes from IO device 112 into the RDMA completion queue. Application program 104 may further program application accelerator 106 with application-specific logic to decode the structure of a completion entry.

Application program 104 may program application accelerator 106 with application-specific logic for each of multiple types of buffers. As an example, application program 104 may program application accelerator 106 with application-specific logic for an RDMA completion queue, and may further program application accelerator 106 with application-specific logic for an NCCL low latency proxy ring.

Application program 104 may program application accelerator 106 to support multiple IO devices (e.g., IO devices 112-1 through 112-n in FIG. 3 and/or FIG. 4).

Application accelerator 106 may support multiple application programs executing (e.g., simultaneously) on processor 108. Each application program may allocate one or more buffers for use by IO device 112 at 502, and may program application accelerator 106 with application-specific logic appropriate for the structure and content of the respective buffers.

Application program 104 may configure application accelerator 106 to detect IO transactions 118 related to application program 104 based on destination addresses and/or device identifiers associated with read and/or write transactions, and to perform desired functions of application program 104 based on the detected IO transactions 118, examples of which are provided further below. In FIG. 4, application program 104 may program match-action tables 447 with instructions/code to be executed by MPUs 444, based on transactions 118.

At 508, processor 108 performs functions (e.g., data processing functions) of application program 104. For illustrative purposes, functions of application program 104 that are performed by processor 108 may be referred to as a first set of functions of application program 104. Functions of application program 104 that are performed by application accelerator 106 may be referred to as a second set of functions of application program 104. The first set of functions may include polling (i.e., reading) completion queue 218, adding entries to submission queue 214, and/or reading entries of receive queue 216.

At 510, as processor 508 performs the first set of functions of application program 104, IO device 112 performs IO transactions for application program 104 and/or for other application programs executing on processor 108. Example are provided below with reference to FIG. 2, for a situation in which IO device 112 conducts transactions with a remote IO device, such as illustrated in FIG. 3. In a first example, IO device 112 sends a message 240 by reading and formatting (e.g., packetizing) an entry 220 of submission queue 214. Entry 220 may include a data/payload and a destination identifier. In a second example, IO device 112 receives a message 242, determines that message 242 relates to application program 104 (e.g., based on a destination address, an originator identifier, and/or other features of message 242), and writes message 242 to receive queue 216 (i.e., via DMA engine 114). IO device 112 may write message 242 to receive queue 216 as-is, and/or may extract content 246 of message 242 (e.g., header information and/or a payload) and write the extracted content 246 to receive queue 216.

Upon completion of an IO transaction (e.g., sending message 240 or writing message 242 or content 246 to memory 110), IO device 112 may write a completion transaction 224 to completion queue 218. Completion transaction 224 may include an identifier of a corresponding entry of submission queue 214 or receive queue 216.

IO device 112 may perform a first or initial IO transaction for application program 104 based on a control from processor 108, and may perform subsequent IO transactions based on controls from application accelerator 106. Alternatively, IO device 112 may perform a first or initial IO transaction for application program 104 based on a control from application accelerator 106.

At 512, as processor 508 executes application program 104 at 508, and as IO device(s) 112 perform functions for application program 104 at 510, application accelerator 106 monitors communication path(s) 116 (e.g., DMA channel 204) for IO transactions related to application program 104. In an example, application accelerator 106 monitors DMA channel 204 for read and/or write transactions directed to memory sub-region 212. Application accelerator 106 may monitor read transactions directed to submission queue 214, write transactions directed to receive queue 216, and/or completion transactions 224 written to completion queue 218. Application accelerator 106 may identify IO transactions related to application program 104 based on destination and/or originator/source identifiers (e.g., destination addresses associated with application program 104).

At 514, when application accelerator 106 detects an IO transaction related to application program 104, processing proceeds to 516. At 516, application accelerator 106 performs a function of application program 104 based on the detected IO transaction.

In an example, where the IO transaction detected at 514 relates to a message 240 sent from IO device 112, application accelerator 106 may control IO device 112 to process a subsequent entry of submission queue 214. In this example, IO device 112 reads a subsequent entry 220 of submission queue 214, formats the subsequent entry 220 as a subsequent message 240, sends the subsequent message 240, and writes a corresponding subsequent completion transaction 224 to completion queue 218. As application accelerator 106 continues monitoring for IO transactions related to application program 104 (at 512), application accelerator 106 may detect the subsequent completion transaction 224 (at 514), and may control IO device 112 to send an additional subsequent message (at 516). In this way, application accelerator 106 may control IO device 112 to continually process entries of submission queue 214, without involving processor 108, which may reduce latency between IO transactions.

In another example, where the IO transaction detected at 514 relates to a message 242 received from IO device 112, application accelerator 106 may send a control to cause IO device 112 to send a subsequent message 242. In this example, IO device 112 receives the subsequent message 242, determines that the subsequent message 242 relates to application program 104, writes the subsequent message to receive queue 216, and writes a corresponding subsequent completion transaction 224 to completion queue 218. As application accelerator 106 continues monitoring IO transactions of IO device 112 (at 512), application accelerator 106 may detect the subsequent IO transaction related to the subsequent message 242, and may send a subsequent control to cause IO device 112 to send an additional subsequent message 242. In this way, application accelerator 106 may control IO device 112 to continually send messages 242, without involving processor 108.

In another example, application accelerator 106 performs a branch function. With a branch function, when application accelerator 106 detects an IO transaction of one of IO devices 112 (or an IO transaction of a remote DMA device), application accelerator 106 performs a function that may involve another one of IO device 112. Application accelerator 106 may, for example, control one or more other IO devices 112 to perform a subsequent IO transaction (e.g., read an entry of submission queue 214 and/or perform some other function(s) for which the IO device is configured to perform).

Alternatively, or additionally, application accelerator 106 may perform a function of application program 104 internally, based on a detected IO transaction. Application accelerator 106 may, for example, decode a payload of a detected write transaction as an application-specific completion descriptor. In another example, application accelerator 106 may record timestamps for IO transactions related to application program 104, as the IO transactions pass through application accelerator 106. Application accelerator 106 may write the timestamps to completion queue 218 (e.g., as completion descriptors), and/or to another buffer (e.g., a circular buffer) of memory sub-region 212. The timestamps may be useful for a transaction-level analyzer (e.g., a PCIe transaction-level analyzer) for performance analysis. In another example, application accelerator 106 performs the transaction-level analysis.

Application accelerator 106 may perform a branch function based on an IO transaction and/or results of an internal function. In an example, where application accelerator 106 decodes a payload of a detected write transaction as an application-specific completion descriptor, application accelerator 106 may perform a branch operation based on contents of the completion descriptor. If the completion descriptor indicates success, for example, application accelerator 106 may directly post additional work to submission queue 214, and/or may perform other programmable behavior(s). In another example, application accelerator 106 modifies the write transaction as it passes through application accelerator 106 based on the completion descriptor, such as by marking a field in completion transaction 224 to indicate that the write transaction was decoded by application accelerator 106.

Application accelerator 106 may cease performing a function of application program 104 in one or more situations, and application program 104 may thereafter assume responsibility for the function. As an example, IO device 112 may decode a payload of a packet as an application-specific completion descriptor, and may write the application-specific completion descriptor to completion queue 218. Further in this example, application program 104 may configure application accelerator 106 to perform a subsequent action based on the application-specific completion descriptor, provided that the application-specific completion descriptor indicates that IO device 112 successfully decoded the payload. If the application-specific completion descriptor indicates that IO device 112 did not successfully decoded the payload, application accelerator 106 may disregard the instructions for performing the subsequent action, and application program 104 may assume responsibility for the subsequent action. Application program 104 may, for example, process the failed decoding based on error handling instructions of application program 104.

Application accelerator 106 may be configurable to perform various combinations of the foregoing examples. Application accelerator 106 is not limited to the foregoing examples.

As described further above with reference to FIG. 4, application accelerator 106 may employ match-action semantics/functions to quickly match IO transactions 118 to functions to be performed by application accelerator 106. A match-action function may include an IO transaction pattern and a corresponding function (e.g., instructions for MPUs 441 in FIG. 4). When application accelerator 106 matches an IO transaction 118 with an IO transaction pattern of a match-action function, application accelerator 106 performs the corresponding function.

Where an IO transaction matches multiple match-action functions, application accelerator 106 may execute the match-action functions in a sequential, or chained manner. The match-action functions may be prioritized based on changes they impart to IO transactions, such that a match-action function that does not alter IO transactions (e.g., timestamps and transaction-level analysis), is performed prior to a match-action function that alters IO transactions (e.g., decoding).

In the preceding, reference is made to embodiments presented in this disclosure. However, the scope of the present disclosure is not limited to specific described embodiments. Instead, any combination of the described features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

As will be appreciated by one skilled in the art, the embodiments disclosed herein may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium is any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit (IC), comprising:
an application accelerator circuit configured to detect an IO transaction related to an application program executing on a processor, and to perform a function of the application program based on the IO transaction.

2. The IC of claim 1, wherein the function comprises controlling an IO device to perform a subsequent IO transaction.

3. The IC of claim 1, wherein the function comprises one or more of:
decoding a payload of the IO transaction;
loading a submission queue of the application program;
assigning a timestamp to the IO transaction; and
performing a transaction-level analysis based on the IO transaction and the timestamp.

4. The IC of claim 1, wherein the function comprises determining an application-specific completion descriptor based on the IO transaction.

5. The IC of claim 4, wherein the application accelerator circuit is further configured to perform an additional function based on the application-specific completion descriptor.

6. The IC of claim 1, wherein the application accelerator circuit is configurable to perform one or more of multiple functions based on the detected IO transaction.

7. The IC of claim 1, wherein the application accelerator circuit comprises discrete logic configured to detect the IO transaction related to the application program and to perform the function based on programmable match-action tables.

8. A system, comprising:
a host device;
a memory device;
an input/output (IC) device; and
a distributed services platform comprising one or more integrated circuit (IC) devices, wherein the distributed services platform comprises, an application accelerator circuit, and
a system-on-chip comprising a processor, memory encoded with an application program that comprises instructions that, when executed by the processor, cause the processor to perform a first function, a host interface configured to interface with the host device, a memory controller configured to interface with the memory device, an offload engine configured to perform a function of one or more the host device and the application program, a processor, and an interconnect configured to interface with the host interface, the memory controller, the offload engine, the processor, and the application accelerator circuit;
wherein the application accelerator circuit is configured to detect an input/output (IO) transaction of the IO device that relates to the application program, and to perform a second function based on the detected IO transaction.

9. The system of claim 8, wherein the instructions, when executed by the processor, further cause the processor to:
allocate a buffer for the application program in the memory;
configure a direct memory access (DMA) engine of the IO device to write to the buffer; and
configure the application accelerator circuit to detect the IO transaction related to the application program based on a destination addresses of a write transaction of the DMA engine.

10. The system of claim 8, wherein the second function comprises controlling the IO device to perform a subsequent IO transaction.

11. The system of claim 8, wherein the second function comprises one or more of:
decoding a payload of the IO transaction;
loading a submission queue of the application program;
assigning a timestamp to the IO transaction; and
performing a transaction-level analysis based on the IO transaction and the timestamp.

12. The system of claim 8, wherein the second function comprises determining an application-specific completion descriptor based on the IO transaction.

13. The system of claim 12, wherein the application accelerator circuit is further configured to perform a third function based on the application-specific completion descriptor.

14. The system of claim 8, wherein the application accelerator circuit is configurable to perform one or more of multiple second functions based on the detected IO transaction.

15. The system of claim 8, wherein the application accelerator circuit comprises discrete logic configured to detect the IO transaction related to the application program and to perform the function, based on programmable match-action tables.

16. A method, comprising:
monitoring a direct memory access (DMA) channel, by an application accelerator circuit, based on a match-action function that includes an input/output (IO) transaction pattern and a corresponding action; and
detecting an IO transaction of the DMA channel that matches the IO transaction pattern, by the application accelerator circuit, based on the monitoring; and
performing the action, by the application accelerator circuit, based on the detecting.

17. The method of claim 16, wherein the action comprises controlling an IO device to perform a subsequent IO transaction.

18. The method of claim 16, wherein the action comprises one or more of:
decoding a payload of the IO transaction;
loading a submission queue of an application program associated with the IO transaction;
assigning a timestamp to the IO transaction; and
performing a transaction-level analysis based on the IO transaction and the timestamp.

19. The method of claim 16, wherein the action comprises:
determining an application-specific completion descriptor based on the IO transaction; and
performing another action based on the application-specific completion descriptor.

20. The method of claim 16, further comprising:
configuring the match-action function of the application accelerator circuit, by a processor, to detect IO transactions related to an application program executing on the processor.
